(19) United States
(12) Patent Application Publication
(10) Pub. No.: US 2026/0148198 A1
(43) Pub. Date: May 28, 2026

(54) APPLIANCE ACCESSORY AND MAINTENANCE SUGGESTION PLATFORM

(71) Applicant: eBay Inc., San Jose, CA (US)

(72) Inventors: Francesc Josep Vilarino Guell, San Jose, CA (US); Supriya Jain, San Jose, CA (US); Ravneet Kaur, San Jose, CA (US); Nhat Nguyen, San Jose, CA (US); Bindia Saraf, Sunnyvale, CA (US)

(21) Appl. No.: 18/958,542

(22) Filed: Nov. 25, 2024

(51) Int. Cl. G06Q 10/20; G06F 40/20; G06Q 30/0601

(52) U.S. Cl. CPC G06Q 10/20; G06F 40/20; G06Q 30/0633; G06Q 30/0643

(57) ABSTRACT

A system is provided that automatically notifies a user to perform maintenance for one or more parts of an appliance. The system automatically detects that an appliance has been purchased by a user and, in response to automatically detecting that the appliance has been purchased by the user, stores, in a database of an online electronic transaction platform, an appliance profile for a user comprising a list of appliances including the appliance associated with the user, the list of appliances being associated with a plurality of manufacturers. The system selects, in the database of the online electronic transaction platform, an individual appliance from the list of appliances and determines a maintenance schedule for one or more parts associated with the individual appliance. The system automatically notifies the user to perform maintenance for the one or more parts according to the maintenance schedule.

### TECHNICAL FIELD

The subject matter disclosed herein generally relates to a special-purpose machine that includes a system for providing maintenance reminders, including computerized variants of such special-purpose machines and improvements to such variants, and to the technologies by which such special-purpose machines become improved compared to other special-purpose machines.

### BACKGROUND

Traditional home maintenance systems often place a significant burden on homeowners and property managers, leading to inefficiencies and wasted resources. Typically, users are required to remember and track maintenance schedules for multiple appliances and household systems, a task that can be overwhelming and prone to human error. This manual approach often results in missed or delayed maintenance, potentially leading to more severe issues and costly repairs down the line.

### BRIEF SUMMARY

In some aspects, the techniques described herein relate to a system including: one or more hardware processors; and at least one machine-storage medium for storing instructions that, when executed by the one or more hardware processors, cause the one or more hardware processors to perform operations including: automatically detecting that an appliance has been purchased by a user; in response to automatically detecting that the appliance has been purchased by the user, storing, in a database of an online electronic transaction platform, an appliance profile for a user including a list of appliances including the appliance associated with the user, the list of appliances being associated with a plurality of manufacturers; selecting, in the database of the online electronic transaction platform, an individual appliance from the list of appliances; determining a maintenance schedule for one or more parts associated with the individual appliance; and automatically notifying the user to perform maintenance for the one or more parts according to the maintenance schedule.

In some aspects, the techniques described herein relate to a system, wherein the operations include: processing information associated with the individual appliance by one or more large language models (LLMs) to identify the one or more parts associated with the individual appliance and the maintenance schedule associated with the one or more parts.

In some aspects, the techniques described herein relate to a system, wherein the operations include: generating a textual prompt that includes a name of the individual appliance, a manufacturer of the plurality of manufacturers of the individual appliance and a request for the one or more parts that are compatible with the individual appliance and associated maintenance schedules; and processing the textual prompt by the one or more LLMs to identify the one or more parts.

In some aspects, the techniques described herein relate to a system, wherein the operations include: determining that a current time corresponds to a time specified by the maintenance schedule for an individual part of the one or more parts; in response to determining that the current time corresponds to the time specified by the maintenance schedule for the individual part, presenting a message that identifies the individual part and includes an option to purchase the individual part; receiving input that selects the option to purchase the individual part; and in response to receiving the input, presenting a set of listings associated with the individual part, each listing in the set of listings enabling the user to complete an online transaction for the individual part.

In some aspects, the techniques described herein relate to a system, wherein the operations include: determining that the user has engaged in an online transaction for a particular item; processing, by the one or more LLMs, information associated with the particular item to identify one or more target appliances that use the particular item; and in response to identifying the one or more target appliances, presenting a message to the user that identifies the one or more target appliances and includes an option to add the one or more target appliances to the appliance profile of the user.

In some aspects, the techniques described herein relate to a system, wherein the operations include: receiving input that selects the option to add the one or more target appliances to the appliance profile; in response to receiving the input, identifying, by the one or more LLMs, a set of parts associated with the one or more target appliances and a corresponding maintenance schedule of the set of parts; and presenting an interactive user interface that identifies the set of parts and the corresponding maintenance schedule of the set of parts.

In some aspects, the techniques described herein relate to a system, wherein the operations include: receiving input that modifies one or more reminders in the maintenance schedule for the set of parts in the interactive user interface.

In some aspects, the techniques described herein relate to a system, wherein determining that the user has performed the online transaction includes receiving a search query for the particular item.

In some aspects, the techniques described herein relate to a system, wherein the operations include: determining that the user has engaged in an online transaction for the individual appliance; automatically adding the individual appliance to the appliance profile of the user; and presenting a message to the user that indicates that the individual appliance has been added to the appliance profile of the user.

In some aspects, the techniques described herein relate to a system, wherein the operations include: identifying, by a large language model (LLM), a set of parts associated with the individual appliance and a corresponding maintenance schedule of the set of parts in response to automatically adding the individual appliance to the appliance profile; and presenting an interactive user interface that identifies the set of parts and the corresponding maintenance schedule of the set of parts with a set of options to customize the maintenance schedule.

In some aspects, the techniques described herein relate to a system, wherein the operations include: receiving input from the user that identifies a third-party appliance aggregation entity, the third-party appliance aggregation entity includes one or more appliances the user posses; in response to receiving the input, using an application programming interface (API) associated with the third-party appliance aggregation entity to retrieve the one or more appliances the user posses; and automatically updating the appliance profile stored in the database of the online electronic transaction platform with the one or more appliances retrieved from the third-party appliance aggregation entity.

In some aspects, the techniques described herein relate to a system, wherein the operations include: determining that individual appliance in the appliance profile of the user meets a time to sell criterion; and in response to determining that individual appliance meets a time to sell criterion, automatically presenting a prompt with an option to the user to generate a listing to sell the individual appliance that the user posses.

In some aspects, the techniques described herein relate to a system, wherein determining that individual appliance in the appliance profile of the user meets the time to sell criterion includes determining that a number of transactions performed for a type of appliance associated with the individual appliance within a threshold interval transgresses a trending threshold.

In some aspects, the techniques described herein relate to a system, wherein the time to sell criterion includes an age of the individual appliance transgressing a threshold age.

In some aspects, the techniques described herein relate to a system, wherein the operations include: receiving a request from the user to perform the maintenance for the one or more parts; and in response to receiving the request from the user to perform the maintenance for the one or more parts, identifying one or more service professionals that perform the maintenance.

In some aspects, the techniques described herein relate to a system, wherein the operations include: receiving input that selects an individual service professional from the one or more service professionals; automatically shipping the one or more parts to the individual service professional; and scheduling service to be performed by the individual service professional in response to receiving the input that selects the individual service professional.

In some aspects, the techniques described herein relate to a system, wherein the maintenance schedule is defined by an individual manufacturer of the plurally of manufacturers associated with the individual appliance.

In some aspects, the techniques described herein relate to a system, wherein the online transaction platform includes an e-commerce platform, and wherein the one or more parts include accessories of the individual appliance.

In some aspects, the techniques described herein relate to a method including: automatically detecting, by one or more hardware processors, that an appliance has been purchased by a user; in response to automatically detecting that the appliance has been purchased by the user, storing, in a database of an online electronic transaction platform, an appliance profile for a user including a list of appliances including the appliance associated with the user, the list of appliances being associated with a plurality of manufacturers; selecting, in the database of the online electronic transaction platform, an individual appliance from the list of appliances; determining a maintenance schedule for one or more parts associated with the individual appliance; and automatically notifying the user to perform maintenance for the one or more parts according to the maintenance schedule.

In some aspects, the techniques described herein relate to a machine-storage medium for storing instructions that, when executed by one or more hardware processors, cause the one or more hardware processors to perform operations including: automatically detecting that an appliance has been purchased by a user; in response to automatically detecting that the appliance has been purchased by the user, storing, in a database of an online electronic transaction platform, an appliance profile for a user including a list of appliances including the appliance associated with the user, the list of appliances being associated with a plurality of manufacturers; selecting, in the database of the online electronic transaction platform, an individual appliance from the list of appliances; determining a maintenance schedule for one or more parts associated with the individual appliance; and automatically notifying the user to perform maintenance for the one or more parts according to the maintenance schedule.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some examples.

FIG. 2 is a block diagram illustrating examples of applications that, in one example, are provided as part of a networked system, in accordance with some examples.

FIG. 3 illustrates the appliance maintenance platform, in accordance with some examples.

FIG. 4 illustrates an appliance user interface provided by the appliance maintenance platform, in accordance with some examples.

FIG. 5 illustrates an example notification provided by the appliance maintenance platform, in accordance with some examples.

FIG. 6 illustrates a routine for generating appliance maintenance notifications, in accordance with some examples.

FIG. 7 is a block diagram illustrating a representative software architecture, which may be used in conjunction with various hardware architectures herein described, in accordance with some examples.

FIG. 8 is a diagrammatic representation of a machine in the form of a computer system within which a set of instructions may be executed for causing the machine to perform any one or more of the methodologies discussed herein, in accordance with some examples.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Traditional home maintenance systems often place a significant burden on homeowners and property managers, leading to inefficiencies and wasted resources. Typically, users are required to remember and track maintenance schedules for multiple appliances and household systems, a task that can be overwhelming and prone to human error. This manual approach often results in missed or delayed maintenance, potentially leading to more severe issues and costly repairs down the line.

Moreover, when maintenance is required, users face the challenge of identifying the correct parts needed for repairs or replacements. This process can be time-consuming and frustrating, as it often involves searching through multiple sources, such as instruction manuals, websites, or contacting various retailers and manufacturers. The lack of a centralized system for managing maintenance information and sourcing parts leads to inefficiencies in both time and resources.

Furthermore, determining the optimal time for maintenance or replacement of appliances is often based on guesswork or generalized schedules, rather than the specific usage patterns and conditions of individual devices. This one-size-fits-all approach can result in unnecessary maintenance or, conversely, delayed attention to critical issues. The absence of a system that can accurately predict and recommend maintenance based on real-time data and usage patterns represents a significant gap in current home maintenance practices. These inefficiencies not only lead to increased costs for homeowners and property managers but also contribute to a higher likelihood of appliance failures, reduced longevity of household systems, and overall decreased satisfaction with home ownership or tenancy.

The present application describes a novel system that addresses these technical challenges. The disclosed techniques automatically detects when an appliance or part/accessory for an appliance is purchased by a user. In response, the disclosed techniques can add the appliance and part/accessory to an appliance profile associated with the user. The disclosed techniques can automatically generate a maintenance schedule for replacing or repairing the appliance and/or parts/accessories. For example, the disclosed techniques can process the appliance profile using an LLM that suggests a reminder schedule for performing the maintenance or repair. The LLM can work together with an electronic commerce platform to automatically identify listings for purchasing the replacement parts/accessories or repair material and can provide this information to the user according to the maintenance schedule in a notification. The notification can include an option for the user to purchase the replacement parts/accessories or repair material directly without having to navigate multiple user interfaces and manuals in search for the right replacement parts/accessories or repair material. This significantly improves the user experience and avoids having repairs go long beyond their maintenance schedules which improves the overall efficiencies of appliances.

In some cases, the disclosed techniques detect conditions relating to a time to sell a particular appliance and/or part/accessory. For example, the disclosed techniques can determine that the appliance profile for a user includes an appliance and/or part/accessory that is currently trending. Namely, the appliance and/or part/accessory can be identified by the electronic commerce platform as having a number of purchase transactions that transgress a threshold within a period of time. In response, the disclosed techniques can trigger a notification to the user that recommends that the user list the appliance and/or part/accessory for sale on the electronic commerce platform (e.g., the electronic marketplace). In some cases, the notification can include an option to automatically generate a listing for selling the appliance and/or part/accessory.

As a result, one or more of the methodologies described herein facilitate solving the technical problem of inventory management presented by conventional methods. As such, one or more of the methodologies described herein may obviate a need for certain efforts or computing resources that otherwise would be involved in managing appliances and their maintenance. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

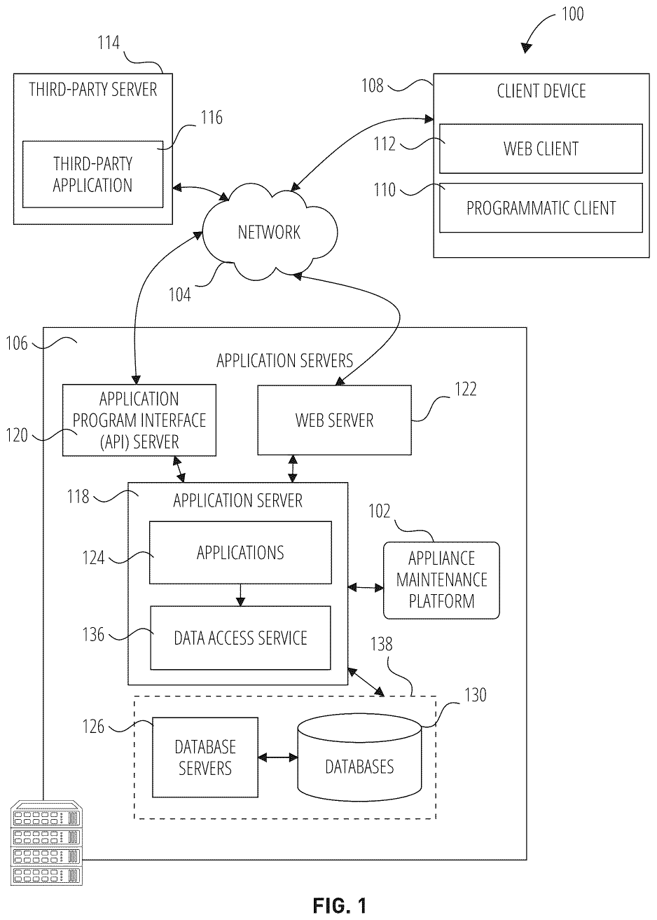

FIG. 1 is a diagrammatic representation of a network environment 100 in which some examples of the present disclosure may be implemented or deployed. One or more application servers 106 provide server-side functionality via a network 104 to a networked user device, in the form of a client device 108. A web client 112 (e.g., a browser) and a programmatic client 110 (e.g., an “app”) are hosted and execute on the web client 112.

An Application Program Interface (API) server 120 and a web server 122 provide respective programmatic and web interfaces to application servers 106. A specific application server 118 hosts an applications 124 and a data access service 136, which includes components, modules and/or applications.

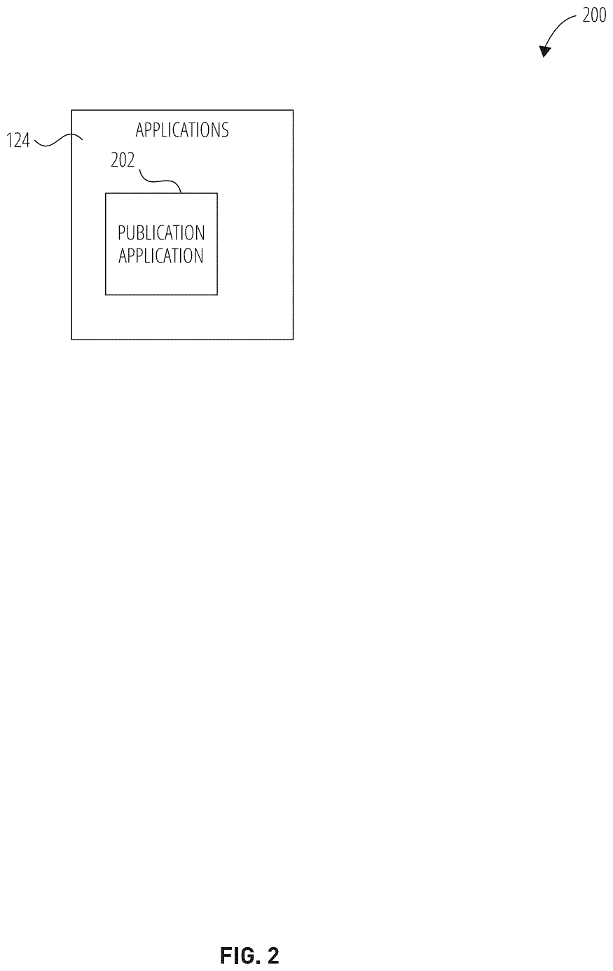

The applications 124 may provide a number of functions and services to users who access the application servers 106. For example, the applications 124 may include a publication application (e.g., publication application 202 of FIG. 2) that enables users to publish content (e.g., product item information) on a hosted web page. While the applications 124 is shown in FIG. 1 to be part of the application servers 106, it will be appreciated that, in alternative examples, the applications 124 may be separate and distinct from the application server 118. The applications 124 can also enable buyers to purchase items from an online electronic commerce platform where users can buy and sell physical (tangible) and/or intangible items.

The data access service 136 coordinates requests from the applications 124 to access services provided by appliance maintenance platform 102 and to access data stored in one or more cache nodes and/or databases 130 of the data access layer 138. For example, the data access service 136 coordinates transaction requests from the applications 124 across distributed database servers of the appliance maintenance platform 102. The appliance maintenance platform 102 can track appliances and/or parts of appliances that are purchased (possessed) by a user and can automatically trigger notifications to perform maintenance for the appliances and/or their parts.

Further, while the network environment 100 shown in FIG. 1 employs a client-server architecture, the examples are, of course, not limited to such an architecture, and could equally well find application in a distributed, or peer-to-peer, architecture system. The applications 124 could also be implemented as a standalone software program, which do not necessarily have networking capabilities.

The web client 112 accesses the applications 124 via the web interface supported by the web server 122. Similarly, the programmatic client 110 accesses the various services, microservices, and functions provided by the applications 124 via the programmatic interface provided by the Application Program Interface (API) server 120. In one example, the programmatic client 110 may, for example, be a seller application (e.g., eBay Application developed by eBay Inc., of San Jose, California) to enable sellers to author and manage listings on the network environment 100 in an offline manner, and to perform batch-mode communications between the programmatic client 110 and the application servers 106. In one example, the programmatic client 110 may, for example, be a buyer (purchaser) application (e.g., eBay Application developed by eBay Inc., of San Jose, California) to enable buyers to search available listings for items on the network environment 100 in an online manner, to select items to purchase, and to perform batch-mode communications between the programmatic client 110 and the application servers 106.

FIG. 1 also illustrates a third-party application 116 executing on a third-party server 114 as having programmatic access to the application servers 106 via the programmatic interface provided by the Application Program Interface (API) server 120. For example, the third-party application 116 may, utilizing information retrieved from the application server 118, support one or more features or functions on a website hosted by a third party. The third-party website may, for example, provide one or more promotional, marketplace, or payment functions that are supported by the relevant applications of the application servers 106.

Any of the systems or machines (e.g., databases, devices, servers) shown in, or associated with, FIG. 1 may be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 108 may be embodied within the network environment 100. Furthermore, some components or functions of the network environment 100 may be combined or located elsewhere in the network environment 100. For example, some of the functions of the client device 108 may be embodied at the application server 118.

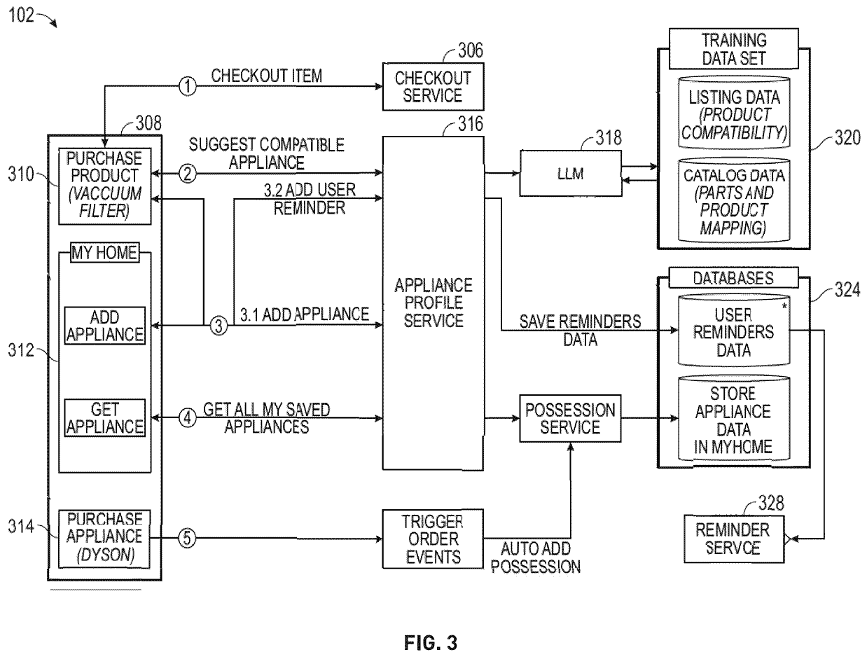

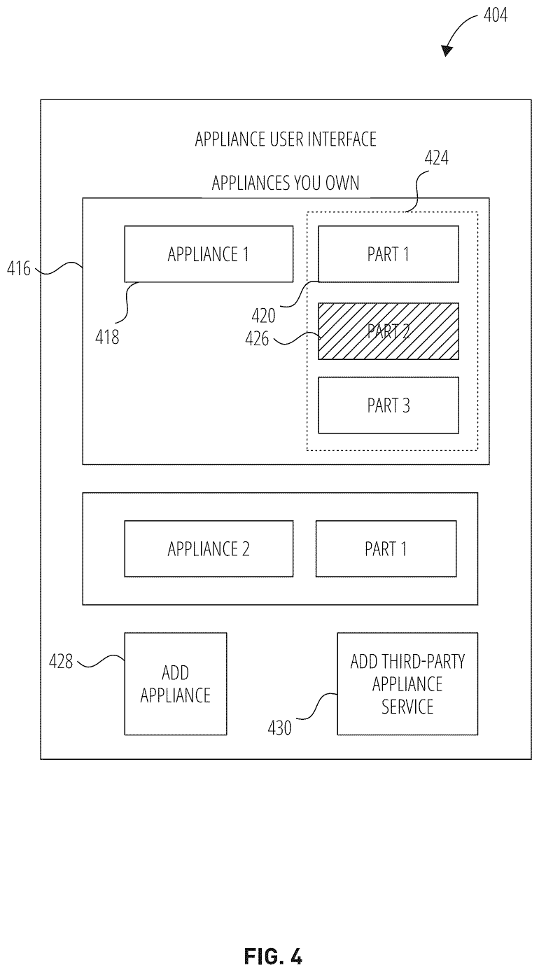

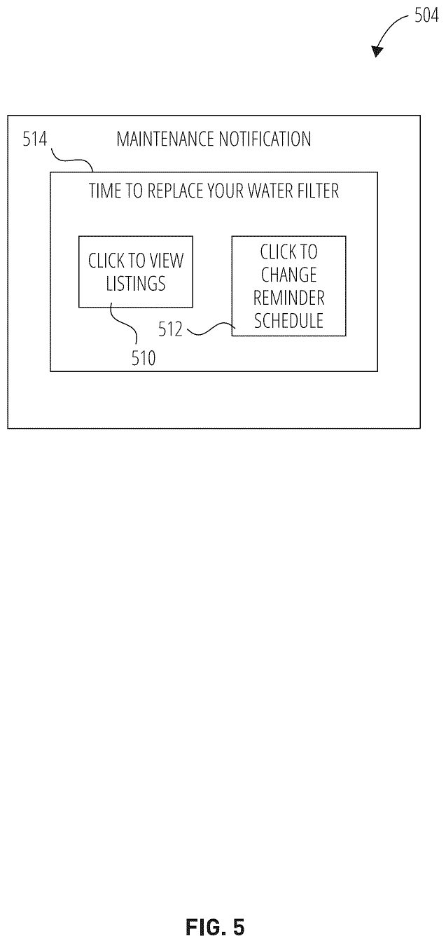

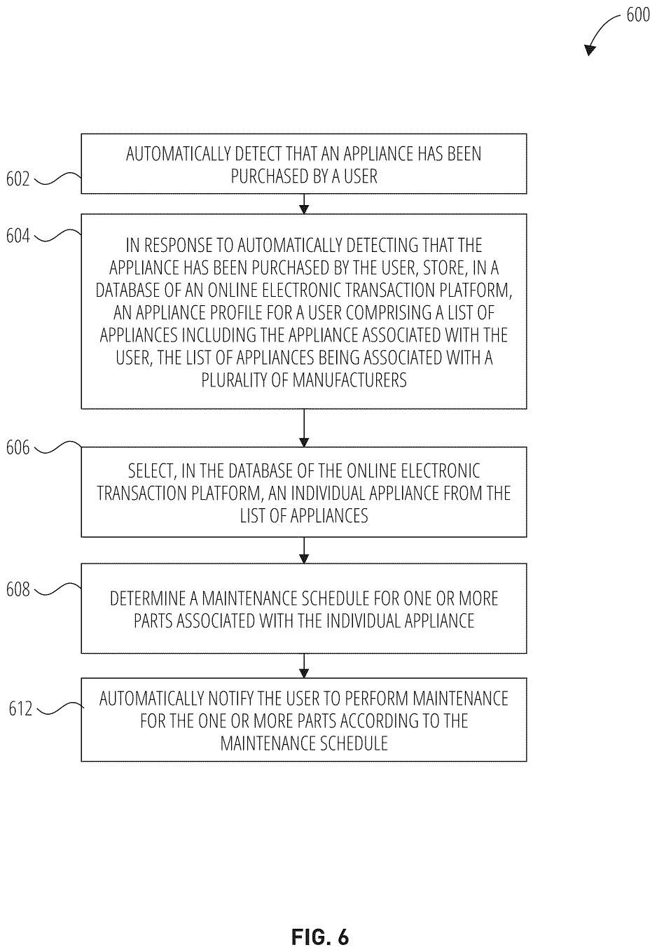

The appliance maintenance platform 102 can automatically notify a user to perform maintenance for one or more parts of an appliance. The appliance maintenance platform 102 automatically detects that an appliance has been purchased by a user and, in response to automatically detecting that the appliance has been purchased by the user, stores, in a database of an online electronic transaction platform, an appliance profile for a user comprising a list of appliances including the appliance associated with the user, the list of appliances being associated with a plurality of manufacturers. The appliance maintenance platform 102 selects, in the database of the online electronic transaction platform, an individual appliance from the list of appliances and determines a maintenance schedule for one or more parts associated with the individual appliance. The appliance maintenance platform 102 automatically notifies the user to perform maintenance for the one or more parts according to the maintenance schedule. Further details of the operations and components of the appliance maintenance platform 102 are provided below in connection with FIG. 3, FIG. 4, FIG. 5, and FIG. 6.

FIG. 2 is a block diagram 200 illustrating the applications 124 that, in one example, are provided as part of the network environment 100. The applications 124 may be hosted on dedicated or shared server machines (not shown) that are communicatively coupled to enable communications between or among server machines. The applications 124 themselves are communicatively coupled (e.g., via appropriate interfaces) to each other and to various data sources, so as to allow information to be passed between or among the applications 124 or so as to allow the applications 124 to share and access common data. The applications 124 may furthermore access one or more databases 130 via the database servers 126.

The application server 118 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the applications 124 is shown to include at least one publication application 202.

In some cases, the applications 124 can provide a graphical user interface (GUI) to a user. The GUI can include an identification of appliances that are owned or associated with the user along with various parts corresponding to each appliance. The GUI can be used by the user to view and/or customize a maintenance schedule for each appliance and/or part. In some cases, the GUI can receive input from the user to add and/or remove one or more appliances from the appliance profile.

FIG. 3 illustrates components and operations of the appliance maintenance platform 102, according to some examples. The appliance maintenance platform 102 includes a checkout service 306, an appliance purchase component 308, an automatic purchase detection component 310, a manual appliance entry component 312, a third-party appliance management component 314, an appliance profile service 316, a large language model (LLM) 318, a training data set 320, appliance databases 324, and a reminder service 328.

LLMs operate as complex neural networks trained on vast amounts of text data to understand and generate human-like text. These models function based on the principles of deep learning and natural language processing. At their core, LLMs use a transformer architecture, which allows them to process and understand context in text more effectively than previous models. The transformer architecture employs a mechanism called “attention,” enabling the model to weigh the importance of different words in a sentence relative to each other, thus capturing long-range dependencies in text.

The training process of LLMs involves exposing the model to enormous datasets of text from various sources, such as books, websites, and articles. During training, the model learns patterns, relationships, and structures in language. This process, known as unsupervised learning, allows the model to develop a broad understanding of language without explicit instruction on grammar rules or specific tasks. One key aspect of LLMs is their ability to perform “few-shot” or “zero-shot” learning. This means they can adapt to new tasks or domains with minimal or no additional training, leveraging their broad knowledge base to understand and respond to prompts in various contexts. LLMs generate text by predicting the most likely next word in a sequence, based on the context provided. This process is iterative, with each predicted word becoming part of the context for the next prediction. The model's output is influenced by various factors, including the input prompt, the model's training data, and any fine-tuning or specific instructions given to the model. While the disclosed techniques are discussed with reference to LLMs, similar functions can be performed by any other suitable generative machine learning model.

Machine learning is a field of study that gives computers the ability to learn without being explicitly programmed. The LLM can be built using machine learning models. Machine learning (e.g., machine learning models) explores the study and construction of algorithms, also referred to herein as tools, that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained at machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve machine learning, in which the training data is structured (e.g., labeled during preprocessing operations), and the trained machine-learning program implements a relatively simple neural network capable of performing, for example, classification and clustering operations. In other examples, the training phase may involve deep learning, in which the training data is unstructured, and the trained machine-learning program implements a deep neural network that is able to perform both feature extraction and classification/clustering operations.

A neural network generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), a Generative Adversarial Network (GAN), and/or a Recursive Neural Network (RNN), merely for example.

During prediction phases, the trained machine-learning program is used to perform an assessment. Query data is provided as an input to the trained machine-learning program, and the trained machine-learning program generates the assessment as output, responsive to receipt of the query data.

In some examples, the appliance maintenance platform 102 can automatically detect that an appliance and/or part of an appliance has been purchased by a user. In response, the appliance maintenance platform 102 adds the appliance and/or part of the appliance to an appliance profile of the user in order to automatically generate reminders to perform maintenance for the appliance according to an automatically generated schedule.

For example, the checkout service 306 can monitor interactions a user performs or conducts with an electronic commerce platform or application, such as searching for a particular appliance and/or part of the appliance and/or conducting a purchase transaction for the appliance and/or part of the appliance. The checkout service 306 can detect that an appliance has been added to a cart of the user. The checkout service 306 can communicate with the appliance purchase component 308 to detect when the appliance has been purchased. The automatic purchase detection component 310 can determine that the user has completed the purchase transaction for the appliance. In response, the automatic purchase detection component 310 communicates an identifier of the appliance (e.g., model number WF45T6000AW, serial number XYZ123456789, or manufacturer SKU ABC-987654) to the appliance profile service 316 in order to add the appliance to an appliance profile of the user. In some examples, the appliance profile service 316 can notify the user by presenting a push notification on the client device 108 that identifies the appliance that has been added to the profile. In some cases, the appliance profile service 316 can generate and present the push notification each time the appliance profile of the user is updated, such as to add or remove parts, accessories, and/or appliances from the appliance profile. This allows the user to approve such modifications and/or revise or undo such modifications.

In some examples, the appliance purchase component 308 presents an interactive user interface to a user on the client device 108. The client device 108 can receive input from the interactive user interface that interacts with the manual appliance entry component 312. The manual appliance entry component 312 enables the user to manually input information for one or more appliances that the user has purchased in the past and/or one or more parts/accessories of an appliance that the user has purchased. Once the appliance purchase component 308 receives input that identifies the appliance and/or parts/accessories and the purchase date, the appliance purchase component 308 communicates this information to the appliance profile service 316 to add the appliance and/or parts/accessories to the appliance profile of the user.

In some examples, the third-party appliance management component 314 can receive input from a user that identifies a third-party appliance management platform. The third-party appliance management component 314 can use an API of the third-party appliance management platform to retrieve a list of appliances that the user has previously added to the third-party appliance management platform or that the third-party appliance management platform has determined to be present in the user's home. The third-party appliance management platform returns to the third-party appliance management component 314 the list of appliances and/or parts/accessories. The third-party appliance management component 314 can then provide that information to the appliance profile service 316 to update the appliance profile for the user. “Dyson” shown in FIG. 3 is an example vacuum brand.

As used herein, the term “appliance” refers to devices or machines designed to perform specific household functions, powered by electricity or gas, and installed semi-permanently within a home or building. Examples include refrigerators, ovens, dishwashers, washing machines, dryers, HVAC systems, and water heaters. Parts or accessories refer to individual components, replaceable elements, or supplementary items that are used in conjunction with or as replacements for appliances. Parts are integral components necessary for the proper functioning of an appliance, while accessories are optional items that enhance or extend the appliance's capabilities. Examples of parts include motors, belts, filters, and electronic control boards. Accessories may include specialized attachments, cleaning kits, or performance-enhancing add-ons.

In some examples, in response to adding the appliance to the appliance profile of the user, the appliance profile service 316 communicates various information about the appliance to the large language model 318. Namely, the appliance profile service 316 can generate a textual prompt that includes a name of the appliance, a manufacturer of the appliance, a date of purchase of the appliance. The textual prompt can include a request to return a list of parts or accessories (any function described with respect to parts is similarly applicable to accessories and vice versa) that correspond to the appliance. The textual prompt can request that for each part or accessory associated with the appliance, a name of the accessory be provided and a frequency of replacement be provided. The appliance profile service 316 can provide the textual prompt to the large language model 318.

The large language model 318 may be trained using training data set 320 (including product compatibility information and parts and product mapping information) to generate an output in response to a prompt. In some cases, the prompt can request a list of compatible parts and their replacement frequency for an identified appliance. In some cases, the prompt can request an appliance that corresponds to and is compatible with a set of parts that have been purchased. The large language model 318 can process the prompt provided by the appliance profile service 316 and can generate a list of the parts or accessories compatible with and/or associated with the identified appliance based on the request in the prompt. The list can include a name of the compatible part and a replacement frequency for the part. The list can also specify various routine maintenance operations that need to be performed for the appliance, such as cleaning various components and the frequency at which the operations need to be performed. The large language model 318 provides this information back to the appliance profile service 316.

In some examples, the replacement frequency for parts can be determined through analysis of comprehensive historical replacement data collected from multiple sources, including manufacturer recommendations, repair records, and real-world performance data. For example, a washing machine's water pump typically requires replacement every 5-7 years under normal usage, while the drive belt may need replacement every 3-4 years. In contrast, a refrigerator's water filter typically needs replacement every 6 months, while its compressor can last 10-15 years under proper maintenance conditions. The frequency can vary significantly based on the specific appliance type, part characteristics, and usage patterns. For instance, a dishwasher used in a household of six people running two loads daily will require more frequent gasket replacements (every 2-3 years) compared to a single-person household running three loads weekly (every 4-5 years). Similarly, an air conditioner operating in a hot, humid climate may require more frequent filter replacements (every 30 days) compared to one in a moderate climate (every 60-90 days). Usage intensity also impacts maintenance schedules-a commercial-grade oven in a restaurant setting might need thermostat replacement every 2 years, while the same part in a residential oven could last 5-7 years under normal home cooking usage.

The large language model 318 can analyzes multiple data points and parameters to generate the list and determine replacement frequencies. The large language model 318 can process historical maintenance records, manufacturer specifications, and usage pattern data to establish correlations between operating conditions and part longevity. For example, when determining the replacement frequency for a dishwasher's spray arm, the large language model 318 considers factors such as water hardness levels in different geographic regions, average load frequency patterns, and documented failure rates from service records. The large language model 318 can also incorporate real-time usage data from connected appliances when available, allowing it to refine its predictions based on actual operating conditions. For instance, if the appliance's sensor data indicates higher-than-average usage or stress patterns, the large language model 318 may adjust its recommended replacement frequencies accordingly.

The appliance profile service 316 can add, to the appliance profile, the list of parts and the routine maintenance operations received from the large language model 318. The appliance profile service 316 can store this information in the appliance databases 324. The appliance databases 324 can include a comprehensive database of devices, including their specifications, common replacement parts, accessories, and lifecycle information. The appliance databases 324 can be integrated with external data sources (manufacturers, product databases) to keep information up-to-date. For example, for a high-end refrigerator model, the appliance databases 324 maintains detailed specifications like dimensions (36″×70″×32″), energy consumption ratings (725 kWh/year), and compatible replacement parts (water filters XYZ-200, ice maker assembly IM-456). The appliance databases 324 also tracks that this particular model typically requires a compressor replacement after 10-15 years and includes information about compatible smart home systems. For a washing machine model, the appliance databases 324 can store information about drum capacity (4.5 cubic feet), motor specifications (1,200 RPM direct drive), and commonly replaced components like door seals (part number DS-789) and drain pumps (DP-567). This information is regularly updated through integration with the manufacturer's service bulletins and technical documentation. For a dishwasher, the appliance databases 324 can maintain records of spray arm configurations, filter systems, and rack specifications, along with compatibility data for different detergent types and water hardness levels. The appliance databases 324 can track common wear patterns, such as gasket deterioration rates and pump assembly lifespans, which are updated based on aggregated service data. For an HVAC system, the appliance databases 324 can store detailed information about compatible thermostats, air filter sizes and types, refrigerant specifications, and seasonal maintenance requirements. This information can be continuously updated through integration with HVAC manufacturer databases and industry standard updates, ensuring technicians have access to the latest compatibility and maintenance specifications. For a cooking range, the appliance databases 324 includes detailed specifications about burner types, oven capacity, electronic control systems, and safety features. The appliance databases 324 can maintain information about compatible replacement parts like heating elements (HE-890), temperature sensors (TS-234), and control boards (CB-567), with regular updates from manufacturer parts catalogs and service manuals.

In some cases, the appliance profile service 316 can determine the purchase date of the appliance based on information provided by the automatic purchase detection component 310. The appliance profile service 316 can automatically generate a schedule for performing maintenance for the appliance including the time when each part needs to be purchased or replaced and the time when the routine maintenance operations need to be performed based on the purchase date. The appliance profile service 316 can instruct the appliance databases 324 to generate automatic reminders according to the generated schedule. The appliance profile service 316 can provide smart suggestions on warranty and service subscription, where the warranty and subscription data are included in the appliance profile service 316. or example, based on the appliance's purchase date, usage patterns, and historical maintenance data, the service can recommend optimal warranty coverage periods and specific service plans. For example, for a high-end refrigerator with smart capabilities, the appliance profile service 316 can make dynamic recommendations based on the appliance's age and condition. For instance, as a washing machine approaches its third year of operation, the appliance profile service 316 can suggest transitioning from the manufacturer's basic warranty to a premium service subscription that includes annual maintenance checks and priority repair service, especially if usage data indicates above-average load cycles. The suggestions can be further tailored based on the specific appliance type and user behavior. For example, for a dishwasher in a household showing heavy usage patterns (multiple cycles per day), the appliance profile service 316 can recommend a comprehensive service subscription that includes quarterly maintenance checks and coverage for wear-prone parts like pump assemblies and spray arms. Conversely, for less frequently used appliances, the appliance profile service 316 can suggest more basic coverage options with annual inspections. The service also considers the cost-benefit analysis of different warranty and subscription options. For instance, for a high-end HVAC system, the appliance profile service 316 can recommend a long-term service contract that includes seasonal maintenance, filter replacements, and priority emergency service, calculating that this would be more cost-effective than paying for individual service calls and repairs over the system's lifetime.

As another example, the checkout service 306 can monitor interactions a user performs or conducts with an electronic commerce platform or application. The checkout service 306 can detect that a part or accessory of an appliance has been added to a cart of the user. The checkout service 306 can communicate with the appliance purchase component 308 to detect when the part or accessory of the appliance has been purchased. The automatic purchase detection component 310 can determine that the user has completed the purchase transaction for the part or accessory of the appliance. In response, the automatic purchase detection component 310 communicates an identifier of the part or accessory of the appliance to the appliance profile service 316 in order to add the part or accessory of the appliance to an appliance profile of the user.

In some examples, in response to adding the part or accessory of the appliance to the appliance profile of the user, the appliance profile service 316 communicates various information about the part or accessory of the appliance to the large language model 318. Namely, the appliance profile service 316 can generate a textual prompt that includes a name of the part or accessory of the appliance, a manufacturer of the part or accessory of the appliance, a date of purchase of the part or accessory of the appliance. The textual prompt can include a request to return a list of appliances that correspond to the part or accessory of the appliance along with additional parts/accessories associated with the listed appliances. The textual prompt can request that for each appliance and for each of the parts or accessories of the appliance, a name of the accessory be provided and a frequency of replacement be provided. The appliance profile service 316 can provide the textual prompt to the large language model 318.

The large language model 318 can process the prompt provided by the appliance profile service 316 and can generate a list of the appliances and/or parts or accessories associated with the listed appliance based on the request in the prompt. The list can include a name of the part and a replacement frequency for the part. The list can also specify various routine maintenance operations that need to be performed for each appliance on the list, such as cleaning various components and the frequency at which the operations need to be performed. The large language model 318 provides this information back to the appliance profile service 316.

The appliance profile service 316 can add, to the appliance profile, the list of appliances and the parts and the routine maintenance operations received from the large language model 318. The appliance profile service 316 can store this information in the appliance databases 324. In some cases, the appliance profile service 316 can determine the purchase date of the part or accessory of the appliance based on information provided by the automatic purchase detection component 310. The appliance profile service 316 can automatically generate a schedule for performing maintenance for the appliance including the time when each part needs to be purchased or replaced and the time when the routine maintenance operations need to be performed based on the purchase date. The appliance profile service 316 can instruct the appliance databases 324 to generate automatically reminders according to the generated schedule.

The appliance purchase component 308 can also receive input from the user to present a list of appliances and parts/accessories that are currently stored in the appliance profile. In response, the appliance purchase component 308 communicates with the appliance profile service 316 to access the appliance profile and retrieve the list of appliances and parts stored in the profile for the user in the appliance databases 324. The appliance purchase component 308 can then present a user interface, such as the appliance user interface 404 shown in FIG. 4. The appliance user interface 404 can allow the user to view the list of appliances and parts/accessories and view the current maintenance reminder schedule for each appliance and/or part/accessory.

The reminder service 328 can compare a current time to a scheduled maintenance time stored for each appliance and/or part/accessory. In response to detecting that the current time matches the scheduled maintenance time for a particular appliance and/or part or if the current time is within a threshold amount of time of the scheduled maintenance time, the reminder service 328 automatically triggers a maintenance notification 504 (shown in FIG. 5) for presentation to the user on the client device 108.

FIG. 4 illustrates an appliance user interface provided by the appliance maintenance platform 102, according to some examples. Specifically, the appliance user interface 404 can be provided automatically for display on the client device 108 in response to any modification that is performed automatically by the appliance maintenance platform 102 to the appliance profile. The appliance user interface 404 can be provided for display on the client device 108 in response a request from the client device 108 to view the appliance profile.

The appliance user interface 404 can include sections for each appliance listed in the appliance profile, such as a first appliance 416 section. The first appliance 416 can include the appliance option 418 that identifies the type of appliance that is included in the first appliance 416 in the appliance profile. The appliance option 418 can include a name of the appliance and can also specify a manufacturer of the appliance. The appliance option 418 can be selected in response to input from the user by the client device 108. In such cases, the client device 108 presents a list of all notifications for maintenance that have been scheduled for the first appliance and/or parts/accessories of the appliance. Each notification can specify the time at which the maintenance notification is scheduled to be triggered for display on the client device 108.

The client device 108 can receive input from the user that modifies or customizes the schedule of the notifications and/or cancels any particular maintenance notification. For example, a notification to replace a water filter can be scheduled to be triggered in three months (based on a purchase date of the first appliance that is a refrigerator). The user may decide to advance the notification to two months, such as because water is consumed at a greater than average rate in the user's home. The notification can be updated based on input from the user and can be triggered to remind the user to replace the water filter in two months instead of three months.

The first appliance 416 section can include a list of parts 424. The list of parts 424 can specify each part for the appliance that has been identified by the large language model 318. The list of parts 424 can specify the names of the parts and the corresponding schedule for the replacement or maintenance notifications. For example, the part option 420 can represent a first part (e.g., a water filter). The part option 420 can be selected based on user input to retrieve and present a list of the scheduled maintenance or replacement reminders for the first part. In some cases, in response to receiving input that selects the part option 420, a window can be presented that looks similar to the maintenance notification 504. The window can include an option to buy now or browse listings on the electronic marketplace of various users that are selling the matching first part (e.g., the component that is compatible with the first appliance. In response to selecting the option to browse listings, a set of multiple listings can be shown with different prices of the first part. The user can select to interact with a particular listing to purchase the first part. In some cases, this can happen in advance of the reminder. In such circumstances, the reminder can be canceled automatically in response to the appliance maintenance platform 102 detecting that the first part was manually purchased in advance of the maintenance notification for that first part.

In some examples, the appliance user interface 404 can visually distinguish options in the list of parts 424 that correspond to parts or appliances that were automatically added based on outputs of the large language model 318. For example, the large language model 318 may have receive a prompt that identifies the first appliance. The large language model 318 may have automatically identified a second part that corresponds to the first appliance (e.g., the first appliance that was purchased by the user). In response, the large language model 318 provides the identification of the second part along with a maintenance schedule (e.g., replacement schedule) for the second part. The appliance user interface 404 can then present the automatically identified part 426 as an option in a different visual manner than options for other parts that were manually added by the user. Namely, the automatically identified part 426 can be presented in a different color than options for the other parts. The automatically identified part 426 can be selected based on user input to view the automatically generated schedule for the second part and/or modify the schedule for the maintenance notifications.

In some examples, the appliance maintenance platform 102 determines that a particular part, such as the second part, is owned by the user. The appliance maintenance platform 102 can determine that the second part is currently trending (e.g., meets a time to sell criterion), such as based on determining that a number of purchases on the electronic marketplace for the second part exceeds a threshold number of purchases within a specified period (e.g., a trending threshold is met). For example, the threshold could be more than 50 purchases of the specific part within a 7-day period, or more than 1,000 views of the part's listing page within a 24-hour period. In such cases, the appliance user interface 404 can visually distinguish the second part in a similar manner as the automatically identified part 426. The appliance user interface 404 can receive input that selects the second part, such as the automatically identified part 426 and, in response, the appliance user interface 404 can automatically generate a listing for selling the automatically identified part 426 on the electronic marketplace. In some cases, the appliance maintenance platform 102 recommends that the user sell the second part in response to determining that an age of the corresponding appliance and/or part transgresses a threshold age.

The appliance user interface 404 can include an add appliance option 428. In response to receiving input that selects the add appliance option 428, the appliance user interface 404 can present a window that allows a user to input various information about one or more appliances that the user possess. This information can then be processed, as discussed above, to add the one or more appliances to the appliance profile and automatically generate parts and accessories (based on outputs of the large language model 318) along with the corresponding maintenance or replacement schedules.

The appliance user interface 404 can include an add third-party appliance service option 430. In response to receiving input that selects the add third-party appliance service option 430, the appliance user interface 404 presents a window allowing a user to input credentials associated with a third-party appliance management platform. The appliance user interface 404 can then use that information along with an API of the third-party appliance management platform to retrieve a list of appliances and/or parts/accessories stored in the third-party appliance management platform for the user account to add those appliances to the appliance profile of the user, as previously discussed.

FIG. 5 illustrates an example maintenance notification 504 provided by the appliance maintenance platform 102, according to some examples. The maintenance notification 504 can include a reminder message 514 with information that identifies the appliance and/or part/accessory for which the reminder was triggered. The maintenance notification 504 includes a view listing option 510 and a change reminder schedule option 512. The view listing option 510 can be selected by user input to browse through listings provided by sellers of the part corresponding to the reminder message 514. The client device 108 can receive input that selects a particular listing and detects that a purchase transaction has been performed for the part. In response, the client device 108 updates the appliance profile to indicate that the part has been replaced and updates automatically the next reminder to perform maintenance for the part. In some cases, the change reminder schedule option 512 can be selected to modify or cancel the scheduled reminder. For example, the change reminder schedule option 512 can be selected to re-trigger the reminder at a specified time, such as in two weeks from the current date.

In some examples, the maintenance notification 504 includes an option to perform the scheduled maintenance on the appliance and/or part. In response to receiving input that selects the option, the appliance maintenance platform 102 identifies one or more service professions within a threshold range of a user's location. The appliance maintenance platform 102 automatically selects one of the one or more service professionals and ships the part identified in the maintenance notification 504 to the selected service professional. The selected service professional can then be scheduled by the appliance maintenance platform 102 to perform the scheduled replacement or maintenance. Once the scheduled replacement or maintenance is completed (as determined by the appliance maintenance platform 102 based on input from the service professional confirming completion on a device of the service professional), the appliance maintenance platform 102 updates the appliance profile to indicate that the part has been replaced and updates automatically the next reminder to perform maintenance for the part.

FIG. 6 illustrates a routine 600 (e.g., method or process) in accordance with some examples. The operations discussed in connection with FIG. 6 can be performed sequentially, in parallel, and in any suitable order.

The operations discussed in FIG. 6 can be performed by the appliance maintenance platform 102. In operation 602, the appliance maintenance platform 102 automatically detects that an appliance has been purchased by a user, as discussed above.

In operation 604, the appliance maintenance platform 102 in response to automatically detecting that the appliance has been purchased by the user, stores, in a database (e.g., databases 130) of an online electronic transaction platform, an appliance profile for a user comprising a list of appliances including the appliance associated with the user, the list of appliances being associated with a plurality of manufacturers, as discussed above.

In operation 606, the appliance maintenance platform 102 selects, in the database of the online electronic transaction platform, an individual appliance from the list of appliances, as discussed above.

In operation 608, the appliance maintenance platform 102 determines a maintenance schedule for one or more parts associated with the individual appliance, as discussed above.

In operation 612, the appliance maintenance platform 102 automatically notifies the user to perform maintenance for the one or more parts according to the maintenance schedule, as discussed above.

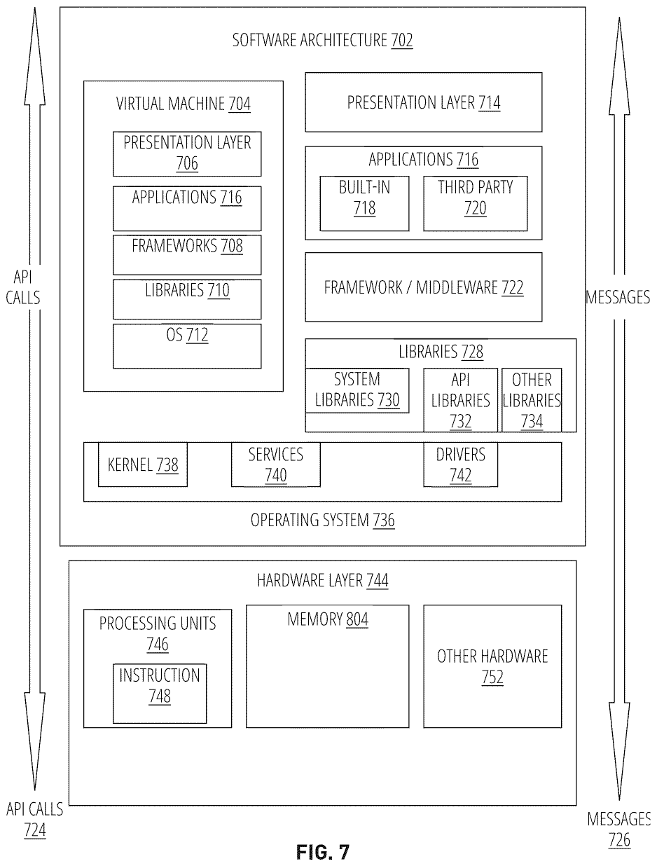

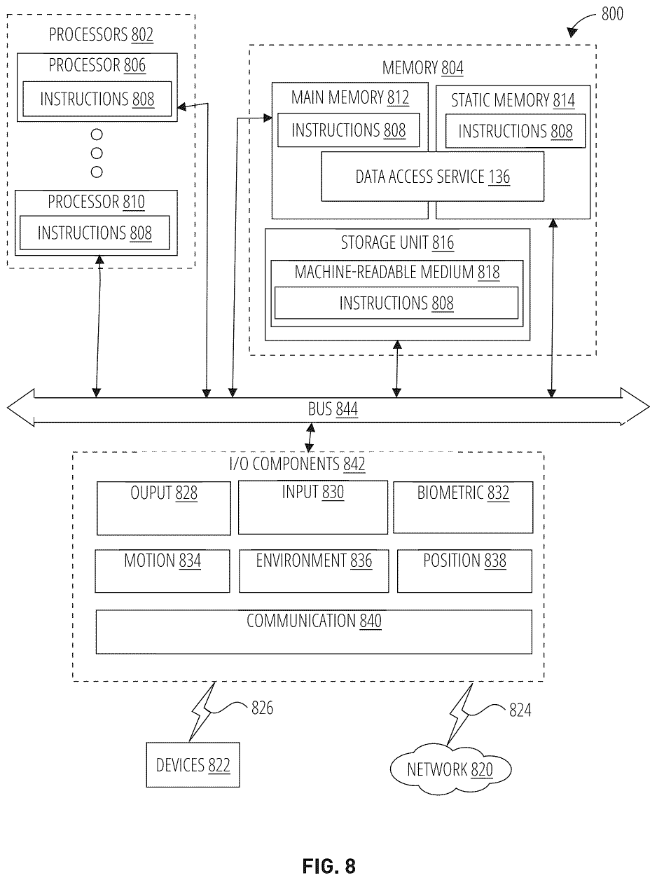

FIG. 7 is a block diagram illustrating an example of a software architecture 702 that may be installed on a machine, according to some examples. FIG. 7 is merely a non-limiting example of a software architecture, and it will be appreciated that many other architectures may be implemented to facilitate the functionality described herein. The software architecture 702 may be executing on hardware such as a machine 800 of FIG. 8 that includes, among other things, processors 810, memory 804, and I/O components 842. A representative hardware layer 744 is illustrated and can represent, for example, the machine 800 of FIG. 8. The representative hardware layer 744 comprises one or more processing units 746 having associated executable instructions 748. The executable instructions 748 represent the executable instructions of the software architecture 702. The hardware layer 744 also includes memory 804, which also have the executable instructions 748. The hardware layer 744 may also comprise other hardware 752, which represents any other hardware of the hardware layer 744, such as the other hardware illustrated as part of the machine 800.

The instructions 748 may be transmitted or received over the network using a transmission medium via a network interface device (e.g., a network interface component included in the communication components 840) and utilizing any one of a number of well-known transfer protocols (e.g., hypertext transfer protocol (HTTP)). Similarly, the instructions 748 may be transmitted or received using a transmission medium via the coupling (e.g., a peer-to-peer coupling) to the devices. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 748 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” are non-transitory computer-readable media and specifically exclude carrier waves, modulated data signals, and other such media, at least some of which are covered under the term “signal medium.”

In the example architecture of FIG. 7, the software architecture 702 may be conceptualized as a stack of layers, where each layer provides particular functionality. For example, the software architecture 702 may include layers such as an operating system 736, libraries 728, framework / middleware 722, applications 716, and a presentation layer 714. Operationally, the applications 716 or other components within the layers may invoke API calls API calls 724 through the software stack and receive a response, returned values, and so forth (illustrated as messages 726) in response to the API calls 724. The layers illustrated are representative in nature, and not all software architectures have all layers. For example, some mobile or special-purpose operating systems may not provide a framework / middleware 722 layer, while others may provide such a layer. Other software architectures may include additional or different layers.

The operating system 736 may manage hardware resources and provide common services. The operating system 736 may include, for example, a kernel 738, services 740, and drivers 742. The kernel 738 may act as an abstraction layer between the hardware and the other software layers. For example, the kernel 738 may be responsible for memory management, processor management (e.g., scheduling), component management, networking, security settings, and so on. The services 740 may provide other common services for the other software layers. The drivers 742 may be responsible for controlling or interfacing with the underlying hardware. For instance, the drivers 742 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 728 may provide a common infrastructure that may be utilized by the applications 716 and/or other components and/or layers. The libraries 728 typically provide functionality that allows other software modules to perform tasks in an easier fashion than by interfacing directly with the underlying operating system 736 functionality (e.g., kernel 738, services 740, or drivers 742). The libraries 728 may include system libraries 730 (e.g., C standard library) that may provide functions such as memory allocation functions, string manipulation functions, mathematic functions, and the like. In addition, the libraries 728 may include API libraries 732 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 728 may also include a wide variety of other libraries 734 to provide many other APIs to the applications 716 and other software components/modules.

The frameworks/middleware 722 (also sometimes referred to as middleware) may provide a higher-level common infrastructure that may be utilized by the applications 716 or other software components/modules. For example, the frameworks/middleware 722 may provide various graphical user interface functions, high-level resource management, high-level location services, and so forth. The frameworks/middleware 722 may provide a broad spectrum of other APIs that may be utilized by the applications 716 and/or other software components/modules, some of which may be specific to a particular operating system or platform.

The applications 716 include built-in applications 718 and/or third-party applications 720. Examples of representative built-in applications 718 may include, but are not limited to, a home application, a contacts application, a browser application, a book reader application, a location application, a media application, a messaging application, or a game application.

The third-party applications 720 may include any of the built-in applications 718, as well as a broad assortment of other applications. In a specific example, the third-party applications 720 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 720 may invoke the API calls 724 provided by the mobile operating system such as the operating system 736 to facilitate functionality described herein.

The applications 716 may utilize built-in operating system functions (e.g., kernel 738, services 740, or drivers 742), libraries (e.g., system libraries 730, API libraries 732, and other libraries 734), or framework/middleware 722 to create user interfaces to interact with users of the system. Alternatively, or additionally, in some systems, interactions with a user may occur through a presentation layer, such as the presentation layer 714. In these systems, the application/module “logic” can be separated from the aspects of the application/module that interact with the user.

Some software architectures utilize virtual machines. In the example of FIG. 7, this is illustrated by a virtual machine 704. The virtual machine 704 creates a software environment where applications/modules can execute as if they were executing on a hardware machine (e.g., the machine 800 of FIG. 8). The virtual machine 704 is hosted by a host operating system (e.g., the operating system 736) and typically, although not always, has a virtual machine monitor, which manages the operation of the virtual machine 704 as well as the interface with the host operating system (e.g., the operating system 736). A software architecture executes within the virtual machine 704, such as an operating system 712, libraries 710, frameworks 708, applications 716, or a presentation layer 706. These layers of software architecture executing within the virtual machine 704 can be the same as corresponding layers previously described or may be different.

FIG. 8 is a diagrammatic representation of the machine 800 within which instructions 808 (e.g., software, a program, an application, an applet, an app, or other executable code) for causing the machine 800 to perform any one or more of the methodologies discussed herein may be executed. For example, the instructions 808 may cause the machine 800 to execute any one or more of the methods described herein. The instructions 808 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 808, sequentially or otherwise, that specify actions to be taken by the machine 800. Further, while only a single machine 800 is illustrated, the term “machine” shall also be taken to include a collection of machines that individually or jointly execute the instructions 808 to perform any one or more of the methodologies discussed herein.

The machine 800 may include processors 802, memory 804, and I/O components 842, which may be configured to communicate with each other via a bus 844. In an example, the processors 802 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 806 and a processor 810 that execute the instructions 808. The term “processor” is intended to include multi-core processors that may comprise two or more independent processors (sometimes referred to as “cores”) that may execute instructions contemporaneously. Although FIG. 8 shows multiple processors 802, the machine 800 may include a single processor with a single core, a single processor with multiple cores (e.g., a multi-core processor), multiple processors with a single core, multiple processors with multiples cores, or any combination thereof.

The memory 804 includes a main memory 812, a static memory 814, and a storage unit 816, both accessible to the processors 802 via the bus 844. The main memory 804, the static memory 814, and storage unit 816 store the instructions 808 embodying any one or more of the methodologies or functions described herein. The instructions 808 may also reside, completely or partially, within the main memory 812, within the static memory 814, within machine-readable medium 818 within the storage unit 816, within at least one of the processors 802 (e.g., within the processor's cache memory), or any suitable combination thereof, during execution thereof by the machine 800.

The I/O components 842 may include a wide variety of components to receive input, provide output, produce output, transmit information, exchange information, capture measurements, and so on. The specific I/O components 842 that are included in a particular machine will depend on the type of machine. For example, portable machines such as mobile phones may include a touch input device or other such input mechanisms, while a headless server machine will likely not include such a touch input device. It will be appreciated that the I/O components 842 may include many other components that are not shown in FIG. 8. In various examples, the I/O components 842 may include output components 828 and input components 830. The output components 828 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 830 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 842 may include biometric components 832, motion components 834, environmental components 836, or position components 838, among a wide array of other components. For example, the biometric components 832 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 834 include acceleration sensor components (e.g., accelerometer), gravitation sensor components, rotation sensor components (e.g., gyroscope), and so forth. The environmental components 836 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 838 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 842 further include communication components 840 operable to couple the machine 800 to a network 820 or devices 822 via a coupling 824 and a coupling 826, respectively. For example, the communication components 840 may include a network interface component or another suitable device to interface with the network 820. In further examples, the communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 822 may be another machine or any of a wide variety of peripheral devices (e.g., a peripheral device coupled via a USB).

Moreover, the communication components 840 may detect identifiers or include components operable to detect identifiers. For example, the communication components 840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as location via Internet Protocol (IP) geolocation, location via Wi-Fi® signal triangulation, location via detecting an NFC beacon signal that may indicate a particular location, and so forth.

The various memories (e.g., memory 804, main memory 812, static memory 814, and/or memory of the processors 802) and/or storage unit 816 may store one or more sets of instructions and data structures (e.g., software) embodying or used by any one or more of the methodologies or functions described herein. These instructions (e.g., the instructions 808), when executed by processors 802, cause various operations to implement the disclosed examples.

The instructions 808 may be transmitted or received over the network 820, using a transmission medium, via a network interface device (e.g., a network interface component included in the communication components 840) and using any one of a number of well-known transfer protocols (e.g., hypertext transfer protocol (HTTP)). Similarly, the instructions 808 may be transmitted or received using a transmission medium via the coupling 826 (e.g., a peer-to-peer coupling) to the devices 822.

Although examples have been described, it will be evident that various modifications and changes may be made to these examples without departing from the broader scope of the present disclosure. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

In view of the disclosure above, various examples are set forth below. It should be noted that one or more features of an example, taken in isolation or combination, should be considered within the disclosure of this application.

Example 1. A system comprising: one or more hardware processors; and at least one machine-storage medium for storing instructions that, when executed by the one or more hardware processors, cause the one or more hardware processors to perform operations comprising: automatically detecting that an appliance has been purchased by a user; in response to automatically detecting that the appliance has been purchased by the user, storing, in a database of an online electronic transaction platform, an appliance profile for a user comprising a list of appliances including the appliance associated with the user, the list of appliances being associated with a plurality of manufacturers; selecting, in the database of the online electronic transaction platform, an individual appliance from the list of appliances; determining a maintenance schedule for one or more parts associated with the individual appliance; and automatically notifying the user to perform maintenance for the one or more parts according to the maintenance schedule.

Example 2. The system of Example 1, wherein the operations comprise: processing information associated with the individual appliance by one or more large language models (LLMs) to identify the one or more parts associated with the individual appliance and the maintenance schedule associated with the one or more parts.

Example 3. The system of Example 2, wherein the operations comprise: generating a textual prompt that comprises a name of the individual appliance, a manufacturer of the plurality of manufacturers of the individual appliance and a request for the one or more parts that are compatible with the individual appliance and associated maintenance schedules; and processing the textual prompt by the one or more LLMs to identify the one or more parts.

Example 4. The system of Example 3, wherein the operations comprise: determining that a current time corresponds to a time specified by the maintenance schedule for an individual part of the one or more parts; in response to determining that the current time corresponds to the time specified by the maintenance schedule for the individual part, presenting a message that identifies the individual part and comprises an option to purchase the individual part; receiving input that selects the option to purchase the individual part; and in response to receiving the input, presenting a set of listings associated with the individual part, each listing in the set of listings enabling the user to complete an online transaction for the individual part.

Example 5. The system of any one of Examples 2-4, wherein the operations comprise: determining that the user has engaged in an online transaction for a particular item; processing, by the one or more LLMs, information associated with the particular item to identify one or more target appliances that use the particular item; and in response to identifying the one or more target appliances, presenting a message to the user that identifies the one or more target appliances and includes an option to add the one or more target appliances to the appliance profile of the user.

Example 6. The system of Example 5, wherein the operations comprise: receiving input that selects the option to add the one or more target appliances to the appliance profile; in response to receiving the input, identifying, by the one or more LLMs, a set of parts associated with the one or more target appliances and a corresponding maintenance schedule of the set of parts; and presenting an interactive user interface that identifies the set of parts and the corresponding maintenance schedule of the set of parts.

Example 7. The system of Example 6, wherein the operations comprise: receiving input that modifies one or more reminders in the maintenance schedule for the set of parts in the interactive user interface.

Example 8. The system of any one of Examples 5-7, wherein determining that the user has performed the online transaction comprises receiving a search query for the particular item.

Example 9. The system of any one of Examples 1-8, wherein the operations comprise: determining that the user has engaged in an online transaction for the individual appliance; automatically adding the individual appliance to the appliance profile of the user; and presenting a message to the user that indicates that the individual appliance has been added to the appliance profile of the user.

Example 10. The system of Example 9, wherein the operations comprise: identifying, by a large language model (LLM), a set of parts associated with the individual appliance and a corresponding maintenance schedule of the set of parts in response to automatically adding the individual appliance to the appliance profile; and presenting an interactive user interface that identifies the set of parts and the corresponding maintenance schedule of the set of parts with a set of options to customize the maintenance schedule.

Example 11. The system of any one of Examples 1-10, wherein the operations comprise: receiving input from the user that identifies a third-party appliance aggregation entity, the third-party appliance aggregation entity comprises one or more appliances the user possess; in response to receiving the input, using an application programming interface (API) associated with the third-party appliance aggregation entity to retrieve the one or more appliances the user possess; and automatically updating the appliance profile stored in the database of the online electronic transaction platform with the one or more appliances retrieved from the third-party appliance aggregation entity.

Example 12. The system of any one of Examples 1-11, wherein the operations comprise: determining that individual appliance in the appliance profile of the user meets a time to sell criterion; and in response to determining that individual appliance meets a time to sell criterion, automatically presenting a prompt with an option to the user to generate a listing to sell the individual appliance that the user possess.

Example 13. The system of Example 12, wherein determining that individual appliance in the appliance profile of the user meets the time to sell criterion comprises determining that a number of transactions performed for a type of appliance associated with the individual appliance within a threshold interval transgresses a trending threshold.

Example 14. The system of any one of Examples 12-13, wherein the time to sell criterion comprises an age of the individual appliance transgressing a threshold age.

Example 15. The system of any one of Examples 1-14, wherein the operations comprise: receiving a request from the user to perform the maintenance for the one or more parts; and in response to receiving the request from the user to perform the maintenance for the one or more parts, identifying one or more service professionals that perform the maintenance.

Example 16. The system of Example 15, wherein the operations comprise: receiving input that selects an individual service professional from the one or more service professionals; automatically shipping the one or more parts to the individual service professional; and scheduling service to be performed by the individual service professional in response to receiving the input that selects the individual service professional.

Example 17. The system of any one of Examples 1-16, wherein the maintenance schedule is defined by an individual manufacturer of the plurally of manufacturers associated with the individual appliance.

Example 18. The system of any one of Examples 1-17, wherein the online transaction platform comprises an e-commerce platform, and wherein the one or more parts comprise accessories of the individual appliance.

Example 19. A method comprising: automatically detecting, by one or more hardware processors, that an appliance has been purchased by a user; in response to automatically detecting that the appliance has been purchased by the user, storing, in a database of an online electronic transaction platform, an appliance profile for a user comprising a list of appliances including the appliance associated with the user, the list of appliances being associated with a plurality of manufacturers; selecting, in the database of the online electronic transaction platform, an individual appliance from the list of appliances; determining a maintenance schedule for one or more parts associated with the individual appliance; and automatically notifying the user to perform maintenance for the one or more parts according to the maintenance schedule.

Example 20. A machine-storage medium for storing instructions that, when executed by one or more hardware processors, cause the one or more hardware processors to perform operations comprising: automatically detecting that an appliance has been purchased by a user; in response to automatically detecting that the appliance has been purchased by the user, storing, in a database of an online electronic transaction platform, an appliance profile for a user comprising a list of appliances including the appliance associated with the user, the list of appliances being associated with a plurality of manufacturers; selecting, in the database of the online electronic transaction platform, an individual appliance from the list of appliances; determining a maintenance schedule for one or more parts associated with the individual appliance; and automatically notifying the user to perform maintenance for the one or more parts according to the maintenance schedule.

What is claimed is:

1. A system comprising:
one or more hardware processors; and
at least one machine-storage medium for storing instructions that, when executed by the one or more hardware processors, cause the one or more hardware processors to perform operations comprising:
automatically detecting that an appliance has been purchased by a user;
in response to automatically detecting that the appliance has been purchased by the user, storing, in a database of an online electronic transaction platform, an appliance profile for a user comprising a list of appliances including the appliance associated with the user, the list of appliances being associated with a plurality of manufacturers;
selecting, in the database of the online electronic transaction platform, an individual appliance from the list of appliances;
determining a maintenance schedule for one or more parts associated with the individual appliance; and
automatically notifying the user to perform maintenance for the one or more parts according to the maintenance schedule.

2. The system of claim 1, wherein the operations comprise:
processing information associated with the individual appliance by one or more large language models (LLMs) to identify the one or more parts associated with the individual appliance and the maintenance schedule associated with the one or more parts.

3. The system of claim 2, wherein the operations comprise:
generating a textual prompt that comprises a name of the individual appliance, a manufacturer of the plurality of manufacturers of the individual appliance and a request for the one or more parts that are compatible with the individual appliance and associated maintenance schedules; and
processing the textual prompt by the one or more LLMs to identify the one or more parts.

4. The system of claim 3, wherein the operations comprise:
determining that a current time corresponds to a time specified by the maintenance schedule for an individual part of the one or more parts;
in response to determining that the current time corresponds to the time specified by the maintenance schedule for the individual part, causing presentation of a message that identifies the individual part and comprises an option to purchase the individual part;
receiving input that selects the option to purchase the individual part; and
in response to receiving the input, causing presentation of a set of listings associated with the individual part, each listing in the set of listings enabling the user to complete an online transaction for the individual part.

5. The system of claim 2, wherein the operations comprise:
determining that the user has engaged in an online transaction for a particular item;
processing, by the one or more LLMs, information associated with the particular item to identify one or more target appliances that use the particular item; and
in response to identifying the one or more target appliances, causing presentation of a message to the user that identifies the one or more target appliances and includes an option to add the one or more target appliances to the appliance profile of the user.

6. The system of claim 5, wherein the operations comprise:
receiving input that selects the option to add the one or more target appliances to the appliance profile;
in response to receiving the input, identifying, by the one or more LLMs, a set of parts associated with the one or more target appliances and a corresponding maintenance schedule of the set of parts; and
causing presentation of an interactive user interface that identifies the set of parts and the corresponding maintenance schedule of the set of parts.

7. The system of claim 6, wherein the operations comprise:
receiving input that modifies one or more reminders in the maintenance schedule for the set of parts in the interactive user interface.

8. The system of claim 5, wherein determining that the user has performed the online transaction comprises receiving a search query for the particular item.

9. The system of claim 1, wherein the operations comprise:
determining that the user has engaged in an online transaction for the individual appliance;
automatically adding the individual appliance to the appliance profile of the user; and
causing presentation of a message to the user that indicates that the individual appliance has been added to the appliance profile of the user.

10. The system of claim 9, wherein the operations comprise:
identifying, by an LLM, a set of parts associated with the individual appliance and a corresponding maintenance schedule of the set of parts in response to automatically adding the individual appliance to the appliance profile; and
causing presentation of an interactive user interface that identifies the set of parts and the corresponding maintenance schedule of the set of parts with a set of options to customize the maintenance schedule.

11. The system of claim 1, wherein the operations comprise:
receiving input from the user that identifies a third-party appliance aggregation entity, the third-party appliance aggregation entity comprises one or more appliances the user possess;
in response to receiving the input, using an application programming interface (API) associated with the third-party appliance aggregation entity to retrieve the one or more appliances the user possess; and
automatically updating the appliance profile stored in the database of the online electronic transaction platform with the one or more appliances retrieved from the third-party appliance aggregation entity.

12. The system of claim 1, wherein the operations comprise:
determining that individual appliance in the appliance profile of the user meets a time to sell criterion; and
in response to determining that individual appliance meets a time to sell criterion, automatically presenting a prompt with an option to the user to generate a listing to sell the individual appliance that the user possess.

13. The system of claim 12, wherein determining that individual appliance in the appliance profile of the user meets the time to sell criterion comprises determining that a number of transactions performed for a type of appliance associated with the individual appliance within a threshold interval transgresses a trending threshold.

14. The system of claim 12, wherein the time to sell criterion comprises an age of the individual appliance transgressing a threshold age.

15. The system of claim 1, wherein the operations comprise:
receiving a request from the user to perform the maintenance for the one or more parts; and
in response to receiving the request from the user to perform the maintenance for the one or more parts, identifying one or more service professionals that perform the maintenance.

16. The system of claim 15, wherein the operations comprise:
receiving input that selects an individual service professional from the one or more service professionals;
automatically shipping the one or more parts to the individual service professional; and
scheduling service to be performed by the individual service professional in response to receiving the input that selects the individual service professional.

17. The system of claim 1, wherein the maintenance schedule is defined by an individual manufacturer of the plurality of manufacturers associated with the individual appliance.

18. The system of claim 1, wherein the online transaction platform comprises an e-commerce platform, and wherein the one or more parts comprise accessories of the individual appliance.

19. A method comprising:
automatically detecting, by one or more hardware processors, that an appliance has been purchased by a user;
in response to automatically detecting that the appliance has been purchased by the user, storing, in a database of an online electronic transaction platform, an appliance profile for a user comprising a list of appliances including the appliance associated with the user, the list of appliances being associated with a plurality of manufacturers;
selecting, in the database of the online electronic transaction platform, an individual appliance from the list of appliances;
determining a maintenance schedule for one or more parts associated with the individual appliance; and
automatically notifying the user to perform maintenance for the one or more parts according to the maintenance schedule.

20. A machine-storage medium for storing instructions that, when executed by one or more hardware processors, cause the one or more hardware processors to perform operations comprising:
automatically detecting that an appliance has been purchased by a user;
in response to automatically detecting that the appliance has been purchased by the user, storing, in a database of an online electronic transaction platform, an appliance profile for a user comprising a list of appliances including the appliance associated with the user, the list of appliances being associated with a plurality of manufacturers;
selecting, in the database of the online electronic transaction platform, an individual appliance from the list of appliances;
determining a maintenance schedule for one or more parts associated with the individual appliance; and
automatically notifying the user to perform maintenance for the one or more parts according to the maintenance schedule.
